(19) United States
(12) Patent Application Publication
(10) Pub. No.: US 2016/0192630 A1
(43) Pub. Date: Jul. 7, 2016

(54) Novelty Item for Fishing

(71) Applicant: Justin A. Kennedy, Dillsboro, IN (US)

(72) Inventor: Justin A. Kennedy, Dillsboro, IN (US)

(21) Appl. No.: 14/987,963

(22) Filed: Jan. 5, 2016

Related U.S. Application Data
(60) Provisional application No. 62/099,862, filed on Jan. 5, 2015.

(51) Int. Cl. A01K 97/00

(52) U.S. Cl. CPC A01K 97/00

(57) ABSTRACT

A novelty item in the shape of a small artificial human arm with a hand, and a hook at the hand end for affixing a fish, so that a photograph of the arm with the fish gives the visual impression that the length of the fish in the photograph is much larger than the actual length of the affixed fish. The artificial arm can be a doll's arm with a hook, on one end of a rod or string, that can extend away from the hand, and a handle at the other end of the rod or string, for pulling the hook against the doll's hand. The artificial arm can be decorated with a tattoo or arm hair, or adorned with a shirt sleeve or other article of apparel, to appear more like a human angler's arm.

### CROSS-REFERENCE TO RELATED APPLICATION

This Application claims the benefit of U.S. Provisional Application No. 62/099,862, flied on Jan. 5, 2015, the disclosure of which is incorporated herein by reference in its entirety.

### BACKGROUND OF THE INVENTION

This invention relates to a novelty item for persons who fish,

Many persons who fish for sport may either catch a fish and then release it, or ice it for later consumption. In either event, they may want to boast to their friends about the size or weight of a fish that has been caught, and may photograph the fish being held by the fisherman's hand. While one can exaggerate a story about the size of a fish that has been caught, a photo of the same catch would help to corroborate the fisherman's tale.

### SUMMARY OF THE INVENTION

The present invention provides a novelty item for holding a fish so that a photograph or other visual recording of the catch can be made.

In an aspect of the invention, an artificial arm is provided with a hook or other securement or means at the hand end of the artificial arm for affixing a fish. The artificial arm, which is of a size significantly shorter in length and smaller in size than an average human adult's arm, gives the appearance of a fish in a photograph thereof that has a length or size that is much larger than the actual length or size of the affixed fish.

The artificial arm is preferably an artificial human arm.

In a further aspect of the invention, the artificial arm can be designed with features or adorned with apparel to give the artificial arm an appearance of belonging to an adult fisherman, such as a rugged outdoorsman.

In another aspect of the invention, the artificial human arm includes a hand. The novelty item also includes a rod disposed on or within the artificial arm, and a hook or other means for affixing a fish, attached to the rod. The hook or other means of affixing can extend from the hand at an end of a rod. The artificial arm can be a doll's arm. A hook is formed at, or attached to, a first or proximal end of a rod that extends away from the hand. The rod can also extend through the hand and along the length of the artificial arm, and extend out the other or distal end of the artificial arm. A handle on the distal end of the rod can be used for drawing the hook against the artificial arm's hand.

In an alternative aspect, a string or other means for pulling or drawing, can extend from the distal end of the rod, typically from within the artificial arm, and out the distal end of the arm. A handle on the distal end of the string can be used for drawing the hook against the artificial arm's hand.

In an aspect of the invention, a novelty item includes an artificial human arm that includes a hand, and a hook or other means for fixing a fish or other object to the hand.

In another aspect of the invention, the artificial arm can be decorated with a tattoo, a scar, freckles, blemishes, veins, or arm hair, or adorned with a shirt sleeve, a watch, or other article of apparel, to appear more like a human angler's arm. The skin texture and color can reflect ethnicity and/or age of a human.

In a further aspect of the invention, a method is provided for capturing a visual image of a fish, including the steps of affixing a fish having a real size or length to a hand of an artificial arm that has a size or length significantly less than an average human adult's arm, and taking a photograph or other visual image of the artificial arm with the fish affixed, to give a visual impression or perception that the fish is of a size or length significantly larger than its actual size. In a further aspect of the invention, the perceived size or length of the fish in the visual image, in comparison to the actual size or length of the fish, is proportional to the typical size or length of an adult's arm, in comparison to the actual size or length of the artificial arm.

### BRIEF DESCRIPTION OF THE FIGURES

The present invention provides a novelty item for a fisherman that allows the fisherman to exaggerate a story about the size of the fish that has been caught, by enabling a photograph or visual image of the fish that is hooked to the novelty item to appear much larger or longer than it is actually. The novelty device is small and durable to fit into a tackle box of any fisherman.

FIG. 1 shows an artificial arm having a hand at one end of the arm, with a hook extending from the hand and a knob handle attach to the hook and extending from the opposite end of the artificial arm.

FIG. 2 shows a view of the artificial arm of FIG. 1, viewed from line 1-1.

FIG. 3 shows the artificial arm of FIG. 1 after the handle has been pulled to draw the hook toward the hand.

FIG. 4 shows an alternative artificial arm having a large ring handle attached to the end of the rod.

FIG. 5 shows an alternative artificial arm having a large ring handle and a string attached to the end of the rod.

FIG. 6 shows another alternative artificial arm having a large ring handle and a string attached to the end of the hook.

FIG. 7 shows the artificial arm of FIG. 1 with a fish affixed to the hook, along size an ordinary US one dollar bill to illustrate the actual relative sizes of the fish and an artificial arm in comparison to the dollar bill as a standard.

FIG. 8 shows the artificial arm of FIG. 6 after the handle has been pulled to draw the hook and the fish toward the hand.

FIG. 9 shows a photograph that might be taken of an artificial arm with a fish drawn up to the hand, with the artificial arm adorned with a shirt sleeve.

FIG. 10 shows a forearm and wrist portion of an artificial arm having a tattoo.

FIG. 11 shows a forearm and wrist portion of an artificial arm having arm hair.

FIG. 12 shows a forearm and wrist portion of an artificial arm having a glove.

FIG. 13 shows the artificial arm with the hook extending upwardly for attach the fish.

FIG. 14 shows a photograph that might be taken of the artificial arm with the fish of FIG. 13, with the artificial arm holding the fish upward in the air.

### DETAILED DESCRIPTION OF THE INVENTION

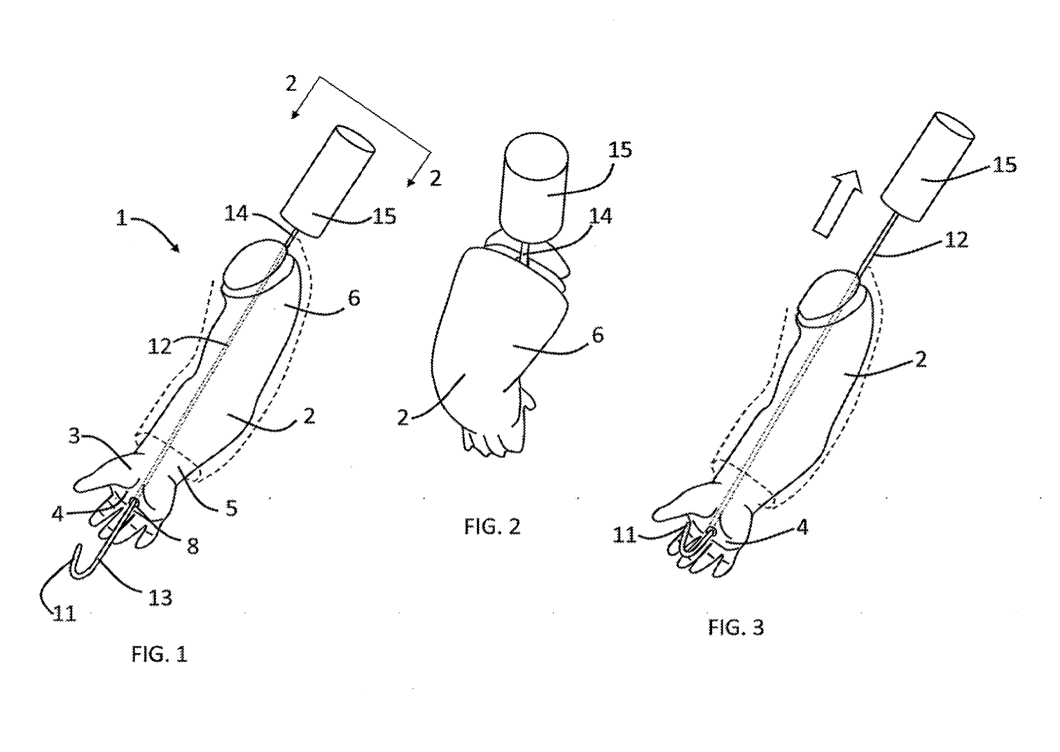

FIGS. 1 and 2 shows a novelty item 1 having an artificial arm 2. The arm has a hand 3 with a palm 4 at a distal end 5 of the arm, and an opposite end 6. The artificial arm 2 can be solid or hollow. The artificial arm 2 is of a size significantly shorter in length and smaller in size than an average human adult's arm.

In one embodiment, the artificial arm is a toy doll's arm, which may be about 4-5 inches in length. The artificial arm can be rigid, or flexible and pliable, or can be malleable and movable. Typically the artificial arm is made of wood, aluminum or other metal, and a resilient material, which can include vinyl, a thermoplastic, and rubber.

A hook 11 is provided as one of a means for affixing a fish, or other object, to the hand 3 of the arm 2. The hook 11 can be formed into one end 13 of a rod 12, or can be a separate element attached to the end of the rod. The hook 11 is inserted into the mouth of a fish, and drawn against the inside of the mouth of the fish, substantially in the same way that a conventional fishing hook is used, although the sharp tip on the end of the hook 11 is not necessary to affix and hoist the fish. The rod 12 can extend through a small hole 8 in the hand 3, and be retained movably within the arm 2, so that the hook 11 moves axially relative to the hand 3, whereby the hook 11 can be moved between an extended position away from the hand 3 and a drawn position adjacent to the hand 3.

The means for affixing a fish, or other object, can also include a spear or other pointed member than can extend through the mouth of a fish, or through the other object, to affix the fish or other object to the rod and/or to the hand of the arm.

The rod 12 extends along the length of the arm 2, with the opposite distal end 14 extending beyond the end 6 of the arm 2. A handle 15 is affixed to the opposite end 6 of the rod 12, to provide a means for pulling or drawing the hook 11 toward and to the hand 3, as shown in FIG. 3, or pushing it away therefrom. The handle is shown as a knob of cylindrical shape, but can be of any other shape or type of handle that facilitates holding the end of the rod, and moving the rod axially within the arm.

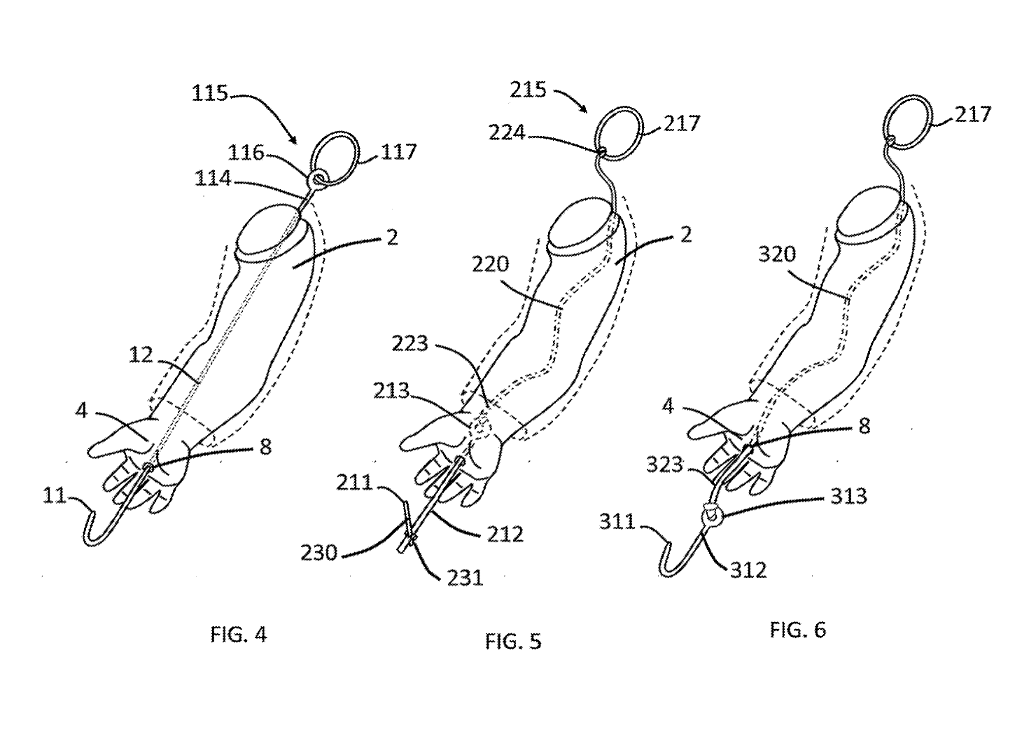

In an alternative embodiment shown in FIG. 4, the handle 115 can include an eyelet 116 at the end 14 of the rod, and a larger-diameter ring 117 through which is inserted a finger of a person (not shown) using the novelty item.

The rod 12 can be sufficiently rigid to hold in extension outwardly without breaking and/or bending when held out upwardly or laterally. The material of the rod and the hook can be any metal, rigid plastic, wood, or composite. The rod can be a solid or hollow cylinder. Likewise, the handle and the ring can be made of the same or different material than that of the rod.

Another alternative embodiment of a handle is shown in FIG. 5, which provides a handle 215 that includes a larger-diameter ring 217 and a string 220 having one end 224 attached to the ring 217 and passed into and along the length of the arm 2. The other end 223 of the string 220 is attached to an eyelet 213 on the end of the shortened rod 212. Pulling on the ring 217 draws the string 220 and the hook 211 toward the hand 3. In a related embodiment shown in FIG. 6, the other end 323 of a longer string 320 can extend through the hole 8 in the palm 4 of the hand 3, and attach directly to an end of a shorter rod 312 having a hook 311, using for example an eyelet 313. A string, can include a thread, a cord, a cable, and an elastic strand.

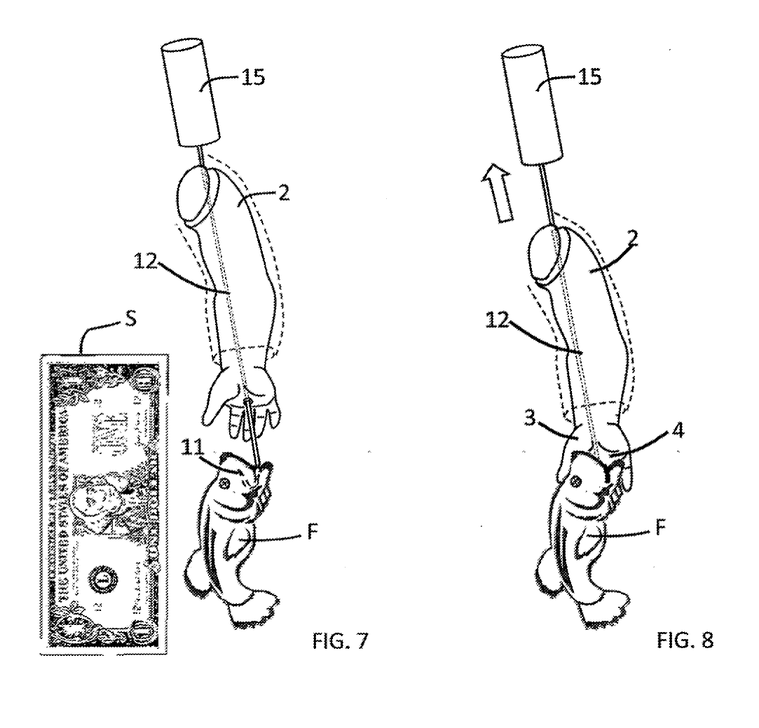

As shown in FIG. 7, a small fish (typically, a live small fish, though it can be artificial) is attached at its mouth to the end of the hook 11, and drawn into the hand 3 by pulling on the handle 15. A size of the small fish is illustrated in comparison to the length of a standard dollar bill. FIG. 7 also shows a typical length of the artificial arm 2, being about or less than the length of a standard US dollar bill (which is about 6 inches in length). The length and size can be a different from the illustrated embodiment. The artificial arm 2 with the hooked fish can then be raised so that the arm and fish hang vertically; or, the arm 12 can be held out horizontally with the hooked fish hanging vertically from the hand 3. The rod 12 or handle 15 can be used for grasping and holding the artificial aim horizontally, supporting weight of the fish.

After the fish F is engaged by the hook. 11, the handle 15 at the end of the rod 12 can be pulled to draw the hooked fish F toward the palm 4, as shown in FIG. 8. When a photograph 100 or other visual image is taken, as shown in FIG. 9, the fish appears to be almost as long as the forearm of the arm, which gives the appearance of a fish in the photograph that has a length or size that is much larger than the actual length or size of the affixed fish. In the example shown in FIG. 6, the actual size of the fish F is less in length that of a standard dollar bill S.

The hook can be a rigid, rounded hook, as shown in FIG. 1, or a V-shaped hook as shown in FIG. 5. The hook can also be made with a short-length bar 230 hinged at the end 231 of the rod 212, as shown in FIG. 5, that can fold in.

In an alternative embodiment, a short rod with the hook on the end can be fixed rigidly and immovably to the hand or the palm of the hand.

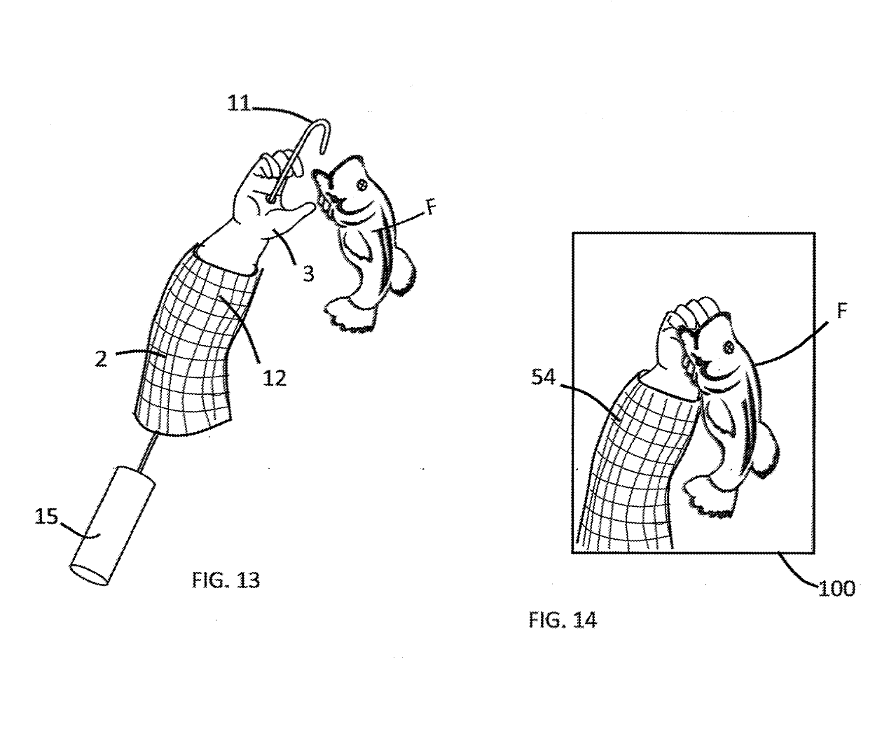

In another aspect of the invention, the artificial arm 2 can be inverted with the hand 3 extending upward, as shown in FIG. 13. In the illustrated embodiment, the hook 411 has a “S” configuration, such that the distal end has an upwardly-extending tip 415. After hooking the fish F onto the hook 411, the photograph 100 can be taken, as shown in FIG. 14, depicting the arm 2 hoisting the fish F upward. It can be understood that the arm 2 and rod 12 can be held to extend down, up or laterally to the side at any angle. It can also he understood that the hook can have any configuration of bends and twists that allow it to hook the end of a fish in various orientations of the arm.

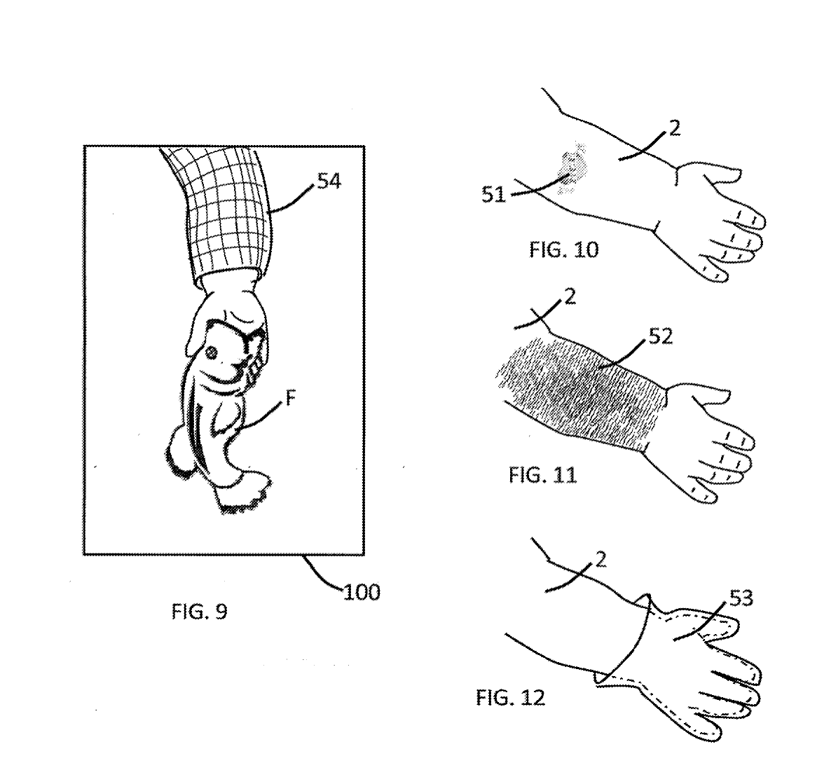

In a further aspect of the invention, the artificial arm can be designed with features or adorned with apparel to give the artificial arm an appearance of belonging to an adult fisherman, such as a rugged outdoorsman. The feature on the arm can include a tattoo 51 as shown in FIG. 10, or arm hair 52 as shown in FIG. 11. The arm 2 can also be adorned with a shirt sleeve 54 as shown in FIG. 9, or with a glove 53 as shown in FIG. 12.

I claim:

1. A novelty item that includes an artificial human arm that includes a hand, and a rod disposed within the artificial human arm and having a proximal end that extends through and from the hand, and a hook fixed at the proximal end of the rod.

2. The novelty item according to claim 1 wherein the artificial human arm is significantly shorter in length and smaller in size than an average human adult's arm.

3. The novelty item according to claim 1 wherein the rod is movable axially relative to the hand, so that the hook can be moved between an extended position away from the hand, and a drawn position adjacent to the hand.

4. The novelty item according to claim 3 wherein a distal end of the rod extends through the arm, and further including a handle secured to the distal end of the rod.

5. The novelty item according to claim 4 wherein the handle is selected from the group consisting of a knob and a large-diameter ring.

6. The novelty item according to claim 3, further including a string having a first end attached to a handle, and a second end attached to the rod.

7. The novelty item according to claim 6 wherein the handle is selected from the group consisting of a knob and a large-diameter ring.

8. The novelty item according to claim 6 wherein the rod extends through the arm, and the handle secures to a distal end of the rod.

9. The novelty item according to claim 1 wherein the artificial human arm can be designed with a feature to give the artificial arm an appearance of belonging to an adult fisherman.

10. The novelty item according to claim 9 wherein the feature is selected from the group consisting of a tattoo, a scar, freckles, blemishes, veins, arm hair, a shirt sleeve, a glove, a watch, and a combination thereof.

11. A novelty item that includes an artificial human arm that includes a hand, a string disposed within the artificial human arm and having a proximal end that extends through and from the hand, and a hook fixed at the proximal end of the string.

12. The novelty item according to claim 11 wherein the artificial human arm is significantly shorter in length and smaller in size than an average human adult's arm.

13. The novelty item according to claim 12 wherein a distal end of the string extends through the arm, and further including a handle secured to the distal end of the string.

14. The novelty item according to claim 13 wherein the handle is selected from the group consisting of a knob and a large-diameter ring.

15. The novelty item according to claim 11 wherein the artificial human arm can be designed with a feature to give the artificial arm an appearance of belonging to an adult fisherman.

16. The novelty item according to claim 15 wherein the feature is selected from the group consisting of a tattoo, a scar, freckles, blemishes, veins, arm hair, a shirt sleeve, a glove, a watch, and a combination thereof.

17. A method for capturing a visual image of a fish comprising the steps of
a. affixing a fish having a size or length to the hand-end of an artificial human arm that includes a hand, and that has a size or length significantly less than an average human adult's arm, and
b. taking a photograph or other visual image of the artificial arm with the fish affixed, to give a visual impression or perception that the fish is of a size or length significantly large than its actual size.
